(19) United States
(12) Patent Application Publication
(10) Pub. No.: US 2004/0068831 A1
(43) Pub. Date: Apr. 15, 2004

(54) Caster construction

(76) Inventors: Jerome C. Caruso, Lake Forest, IL (US); Steven J. Caruso, Antioch, IL (US)

Correspondence Address: BRINKS HOFER GILSON & LIONE, P.O. BOX 10395, CHICAGO, IL, 60611, US

(21) Appl. No.: 10/613,526

(22) Filed: Jul. 3, 2003

Related U.S. Application Data
(60) Provisional application No. 60/394,048, filed on Jul. 6, 2002.

(51) Int. Cl. B60B 33/00

(52) U.S. Cl. 16/18 R

(57) ABSTRACT

A caster assembly including a housing including a first side portion and a second side portion. The first side portion and the second side portion each have an opening. An axle extends between the first side portion and the second side portion and includes two end portions. The first side portion includes a first snap element and the first end of the axle includes a second snap element in a snap fit arrangement with the first snap element. The second side portion of the housing includes a third snap element and the second end of the axle includes a fourth snap element in a snap fit arrangement with the third snap element. A wheel disposed between the first side portion and the second side portion, with the axle positioned in a central axial opening in the wheel.

### RELATED APPLICATIONS

This application claims the benefit of U.S. Provisional Patent Application No. 60/394,048, filed Jul. 6, 2002, the entire disclosure of which is hereby incorporated herein by reference.

### FIELD OF THE INVENTION

The present invention relates generally to casters and specifically to a more efficient manner of constructing certain casters. Such caster construction is applicable to those known as single wheel casters as well as those known as dual wheel casters.

### BACKGROUND

In the art of caster construction, several methods are known that provide for the necessary wheeling of devices such as chairs, carts, cabinets, etc. Broadly speaking, casters can be divided in two fashions, fixed casters vs. active casters, and single wheel vs. multiple wheels. A fixed caster lacks an offset action, but is still classified as a caster. Often, it is desirable to have such casters sized relatively small. There are several reasons for this, ranging from aesthetic to functional considerations. When a caster is sized small, several challenges exist because the caster often will have to be as strong as its larger counterpart. Typically, small casters are multiple wheel casters. Most recent caster developments have centered on multi-wheel casters, usually having two wheels. While these casters are satisfactory for some applications, studies have shown that a single wheel caster performs, or “casters,” more efficiently.

A structural difficulty in single wheel casters is the length of the pivot pin or stem. If a designer is to maintain a given wheel diameter, and maintain the overall height of a caster, this pin can only be so long before it interferes with the wheel. Conversely, on a dual wheel caster, the two wheels can straddle this pin and so it can be extend a longer distance vertically between the two wheels. Another structural difficulty is the interface of the caster assembly with the device it is to support. In the past, one of the only viable solutions has been the expensive option of outfitting a (usually) steel caster with a ball bearing raceway, consisting of a formed lower cup, upper cup, ball bearings, and a headed shouldered pin. This approach is not only costly, but it is usually not a clean solution in that exposed grease surfaces are present. Additionally, it is also very difficult to achieve the strength necessary, as well as the fact that longevity of the product is often reduced.

Some single wheel caster designs have been configured with two piece housings, as shown, for example, in U.S. Pat. No. 4,689,848. However, these designs have featured complicated and expensive designs for connecting the two housing pieces. For example, they have required mating holes and projections to connect the two housing pieces. Also, in previous designs, the pivot pin, which connects the housing to the piece of furniture or other object, is attached to only one of the housing pieces and is not used to hold the housing pieces together.

Thus, there is a need for all classifications of casters to be constructed in a way that will reduce cost, number of parts, and facilitate ease of assembly. Additionally, designers desire an aesthetic alternative to the tired look of current caster offerings.

### SUMMARY

In one aspect, one embodiment of a caster assembly includes a housing including a first side portion and a second side portion. The first side portion and the second side portion each have an opening. An axle extends between the first side portion and the second side portion and includes two end portions. The first side portion includes a first snap element and the first end of the axle includes a second snap element in a snap fit arrangement with the first snap element. The second side portion of the housing includes a third snap element and the second end of the axle includes a fourth snap element in a snap fit arrangement with the third snap element. A wheel disposed between the first side portion and the second side portion, with the axle positioned in a central axial opening in the wheel.

According to another aspect, a method of assembling a caster assembly is provided. In one embodiment, the method includes providing a housing having a first side portion and a second side portion. The first side portion and the second side portion each have an axle opening. The method also includes providing a wheel with a central axial opening and providing an axle with a first and second end portion. The method also includes inserting the axle in the central axial opening of the wheel, snap fitting the first end portion of the axle into the first axle opening; and snap fitting the second end portion of the axle into the second axle opening.

The present embodiments provide significant advantages over prior caster assemblies and methods of caster construction. These caster or wheel assembly features a reduced number of components and fasteners resulting in greater economy and greater reliability. The present embodiments are easier to manufacture and require fewer tools to assemble than conventional designs. The designs of the present embodiments have many features built in, thus limiting the use of traditional fasteners or other techniques such as welding.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a perspective view illustrating the caster assembly in its fully assembled state.

FIG. 2 is an alternative view of the fully assembled caster.

FIG. 3 shows the caster partially disassembled.

FIG. 4 shows the caster fully disassembled.

FIG. 5 is a perspective view showing an alternate caster pin axle with attachment plate.

FIG. 6 is an exploded view of an alternative embodiment of the caster assembly.

FIG. 7 shows a fully assembled alternative embodiment of the caster assembly.

### DETAILED DESCRIPTION OF THE PRESENTLY PREFERRED EMBODIMENTS

It should also be understood that in certain instances details have been omitted which are not necessary for an understanding of the present invention, such as conventional details of fabrication and assembly.

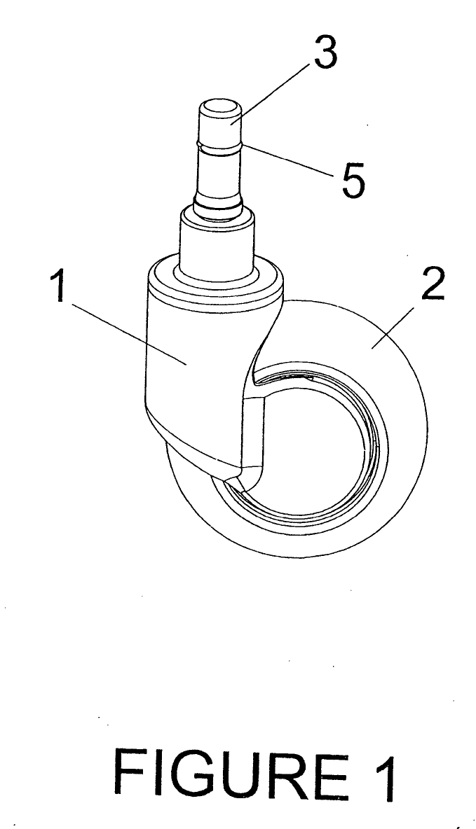

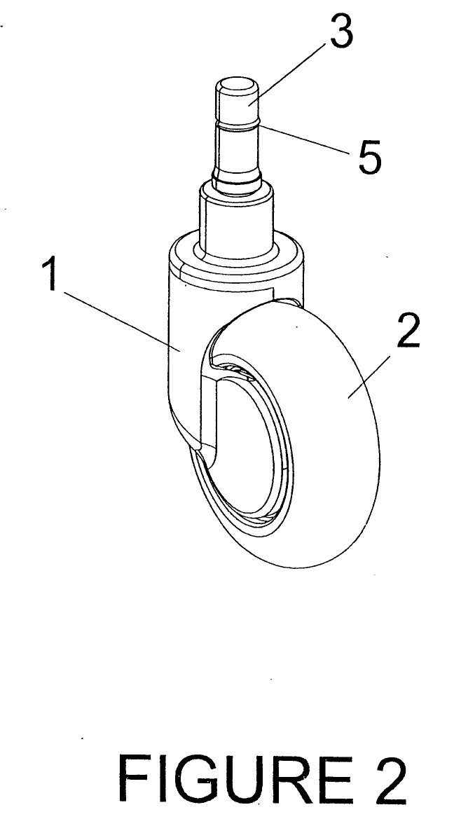

FIGS. 1 and 2 show an embodiment of the caster assembly in its fully assembled state. The embodiment includes a side body 1, a wheel 2, a caster stem or pivot pin 3, and a friction grip retainer ring 5. Such a caster assembly is commonly used on various items such as chairs, carts, gurneys, etc. While this disclosure is primarily directed at new and novel constructions of relatively small, single wheel casters, many of the techniques disclosed are equally applicable to larger single wheel casters or multiple wheel casters of any size.

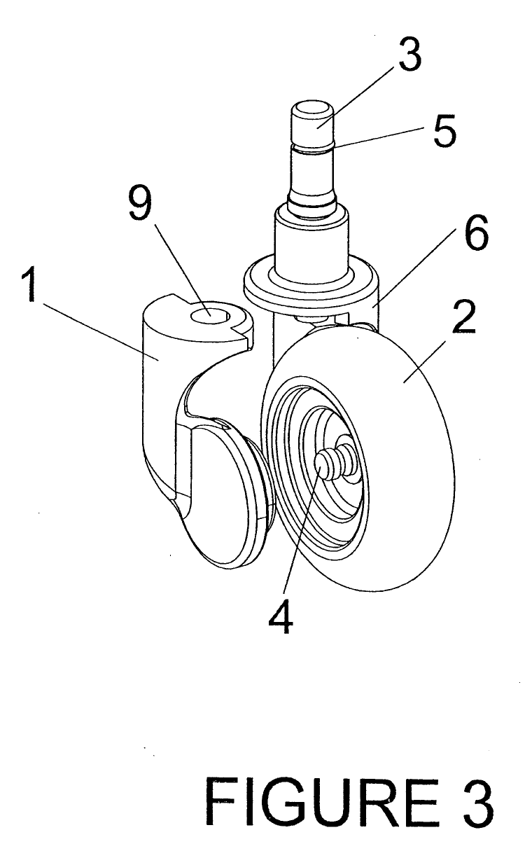

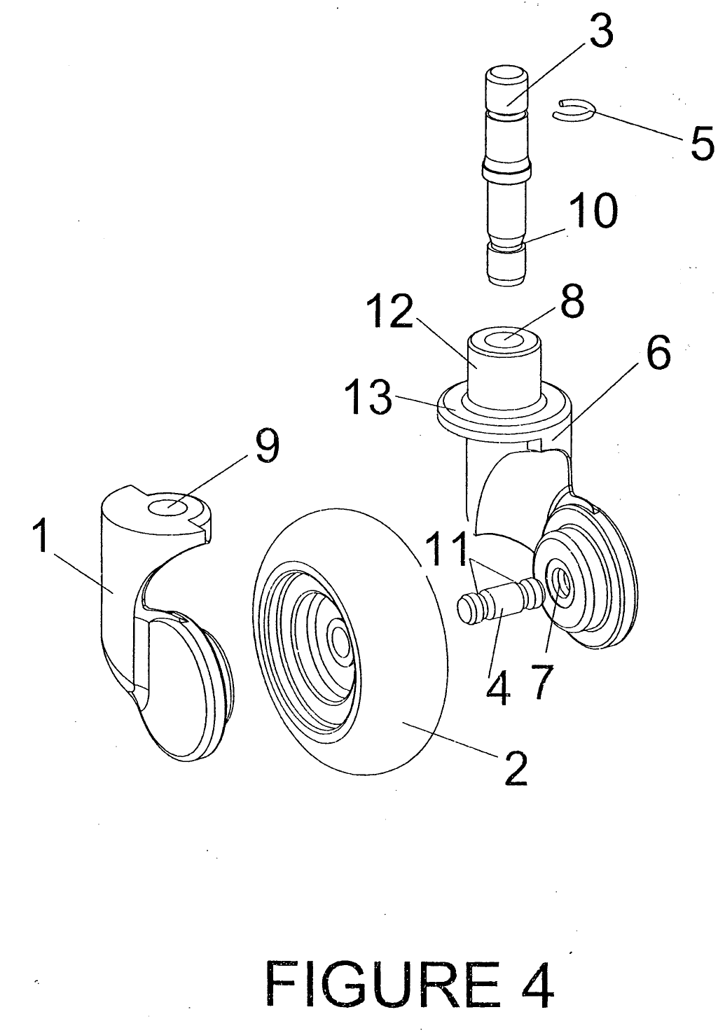

As already mentioned, one of the challenges in designing an economical single wheel caster regards structural considerations. Referring to FIG. 3, the caster can be pivotally secured to various components via its pivot pin 3. Such components include, for example and without limitation, furniture, legs, cabinets, etc. This pivot pin is commonly referred to as a caster's “stem.” Referring to FIG. 4, it can be seen that if a designer is to maintain a given wheel diameter and a standard caster offset, and also maintain the overall height of a caster (measured from the top of the pivot stem 3 to the floor) this pin can only be so long before it interferes with the wheel 2. Conversely, on a dual wheel caster, the two wheels can straddle this pin and so it can be extend a longer distance vertically between the two wheels. A unique feature of this invention that addresses this problem lies in this caster's design interface with the object it is to support.

Other aspects of the invention will now be discussed. For reasons ranging from economy to reliability, it is desirable to optimize the body configuration and have a caster that has as many assembly features built in as possible, thus limiting or eliminating the use of traditional fasteners or other techniques such as welding (for metals) or sonic or solvent welding (for plastics).

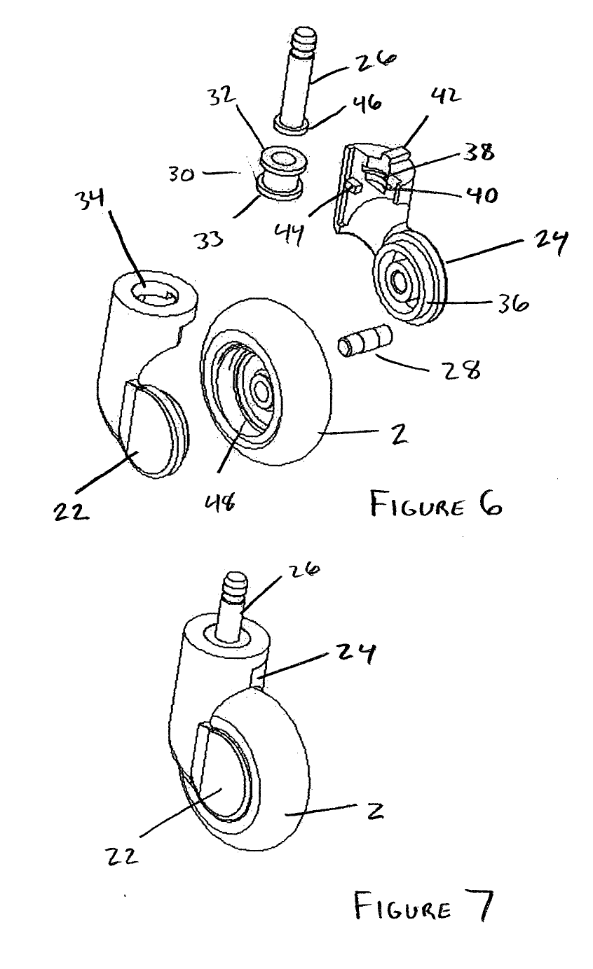

Referring to FIGS. 3 and 6, the materials primarily considered for this invention are plastic for side bodies 1, 6, 22, and 24 and the wheel 2, and steel for the wheel axle 4, the wheel axle 28, the spool 30, the pivot pin 26, and the pivot pin 3. These material choices are considered to be the best mode at this time of disclosure; however, it will be apparent to those skilled in the art that the components of the invention could be made out of any suitable alternatives and still fall within the spirit and scope of the invention.

Referring to FIG. 4, side body 6 has an axle hole 7. Side body 1 has a similar hole but it cannot be seen in this view. The axle holes have one or more circumferential undercut ribs or ridges molded integral to the side body molding 1 and side body molding 6. When assembled, these “doughnut” protrusions will line up with the circumferential grooves or snap details 11 formed on the wheel axle 4. The molded protrusions allow the axle to turn, if desired, yet limit lateral movement and thus retain the axle in the side body moldings.

A similar snap feature may be incorporated into either caster stem/pivot pin hole 8 of side body 6 or caster stem/pivot pin hole 9 in side molding 1, or both. This circumferential rib or snap doughnut lines up with the circumferential groove or snap detail 10 of caster stem/pivot pin 3. Caster pin axle 3 is of generally standard configuration with a friction grip retainer ring 5 fitted to caster pin axle 3.

In another embodiment of the snap features, not shown in the Figures, the axle has circumferential ribs and the axle holes have circumferential grooves. Similarly, in another embodiment, the pivot pin has circumferential ribs and the pivot pin holes have circumferential grooves. These alternative embodiments also allow the axle or pivot pin to be easily snap fit into their respective holes. The term “snap fit” refers to connecting the snap element of one component to the snap element of another component. Other possible snap elements besides ridges and grooves are also possible, including, for example and without limitation, ball and spring detents, cantilevers, and tabs.

Referring to FIG. 4, one embodiment includes a boss 12, which extends the support area for pin 3 considerably. The boss 12 and the step 13 form a shoulder. Such a boss can be configured to fit within the object it is to support. One such item that is specifically considered is a chair, or chair base. By configuring the chair leg, chair base, or other item to be supported (none of which are shown) to accept boss 12 in an appropriate counter bore or other clearance, the caster visually terminates at step 13, yet functionally has the strength required, with the boss and pin absorbing the load.

Assembly of the entire unit is as follows: the wheel axle 4 is either inserted into the wheel 2, and then into either of the axle holes of the bodies such as axle hole 7 of side body 6, or into one of the side body axle holes first, and then the wheel in put onto the axle 4. Then, the axle is snapped onto the other side body, with the wheel 2 disposed between the two side bodies. Once the snap details 11 of the wheel axle 4 snap into the undercut doughnuts of the side bodies the side bodies are held together and the wheel is retained. The wheel 2 may either rotate on the axle or alternatively, the axle may be free to rotate in both side body 1 and side body 6. The wheel 2 may also rotate on the hubs of the side bodies 1 and 6. The next step is to further lock the side moldings together and at the same time retain the pivot pin 3. In particular, pivot pin 3 is inserted into pivot pin hole 8 formed in the side body 6, where it passes through side body 6 and into the opening 9 formed in the side body 1. As stated before, the locking snap doughnut could be in either side body 1 or side body 6, so long as the pivot pin passes through or into both. Although the assembly steps have been described in a particular order, it will be readily apparent to those skilled in the art that other orders of the steps are possible and that the scope of the present invention encompasses variations in the order of the steps.

FIGS. 6 and 7 show another embodiment of the caster assembly. The embodiment includes a first side body 22, a second side body 24, a wheel 2, a pivot pin 26, and a spool 30. Because the housing in this embodiment has a flat upper surface, it has the advantage of providing a universal fit to any furniture accessory without requiring a counter bore to correspond to a boss. The pivot pin 26 includes a base 46 with a diameter larger than that of the main shaft of the pivot pin 26. The spool 30 is hollow and includes two flanges 32 and 33. The spool 30 acts to distribute the load of the pivot pin, and can also act as a bearing. In another embodiment, the spool 30 includes a ball bearing raceway. An internal bearing has several advantages, including greater protection from dust and other outside contaminants. In an alternative embodiment, the spool 30 is integrated with the pivot pin 26 into a single piece. The pivot pin 26 slides into the spool 30, with the base 46 being of larger diameter than the channel in the spool 30. The side body 24 has key features 42 and 44, which mate with corresponding key features, configured in one embodiment as openings, in side body 22. Side body 24 also has slots 38 and 40 which accommodate the spool flange 33 and the pivot pin base 46, respectively. Side body 22 also has similar slots (not shown). In one embodiment, side body 24 has a hub 36, which extends into the rim area 48 of wheel 2. Side body 22 has a similar hub (not shown). The hubs keep dirt and other foreign matter out of the axle area. The wheel is supported by an axle 28, which optionally has snap fittings on each end to connect into the axle holes in the housing.

In assembling the alternative embodiment shown in FIGS. 6 and 7, the pivot pin 26 is inserted into the spool 30, so that the base 46 is adjacent to the flange 33. The assembled pivot pin 26 and spool 30 are then inserted into the hole 34 in side body 22. The axle 28 is then inserted into wheel 2. The axle 28 is inserted into the axle holes in side bodies 22 and 24. The side bodies 22 and 24 are pressed together, with key features 42 and 46 mating to corresponding features in side body 22, and base 46 sliding into slot 40 and flange 33 sliding into slot 38. The side bodies 22 and 24 may then be sonically welded together, or secured with adhesive or fasteners. The axle 28 may optionally have snap fittings, but does not need them because the sonically welded housing holds the axle in place. Although the assembly steps have been described in a particular order, it will be readily apparent to those skilled in the art that other orders of the steps are possible and that the scope of the present invention encompasses variations in the order of the steps.

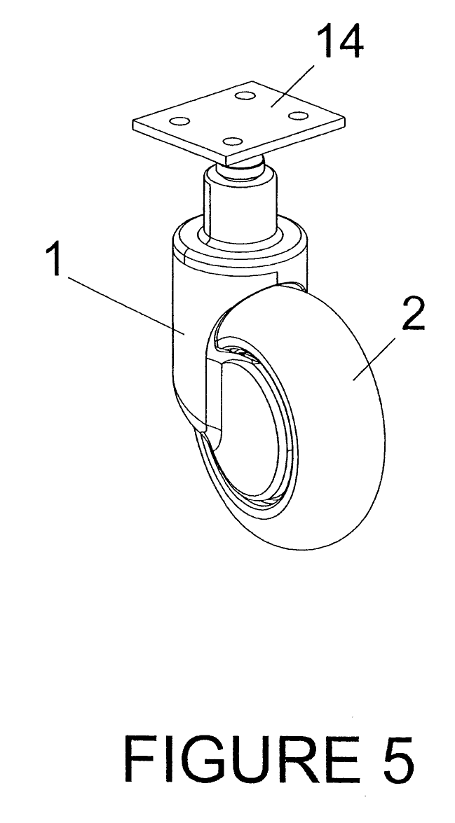

FIG. 5 shows an alternative caster pin axle arrangement with attachment plate 14. Use of attachment plate 14 permits greater flexibility in attaching the caster assembly to the desired structure, allowing the caster assembly to be screwed or welded to the structure that is to be supported.

Thus, an improved caster design and improved methods for the construction of caster wheel assemblies have been disclosed that address the shortcoming of other methods of caster construction. Additionally, such caster or wheel assembly features a reduced number of components or fasteners, resulting in greater economy, ease of assembly and greater reliability.

The embodiments described above and shown herein are illustrative and not restrictive. In certain cases, materials of construction have not been described; in these cases, it is to be understood that the invention may be made by any known method and of any known material. The scope of the invention is indicated by the claims rather than by the foregoing description and attached drawings. The invention may be embodied in other specific forms without departing from the spirit of the invention. Accordingly, these and any other changes which come within the scope of the claims are intended to be embraced therein.

We claim:

1. A caster assembly comprising:
a housing comprising a first side portion and a second side portion, wherein the first side portion and the second side portion each have an opening;
an axle extending between the first side portion and the second side portion, the axle comprising two end portions;
wherein the first side portion comprises a first snap element and the first end of the axle comprises a second snap element in a snap fit arrangement with the first snap element, and wherein the second side portion of the housing comprises a third snap element and the second end of the axle comprises a fourth snap element in a snap fit arrangement with the third snap element; and
a wheel disposed between the first side portion and the second side portion, the wheel having a central axial opening, wherein the axle is positioned in the central axial opening.

2. The caster assembly of claim 1, wherein one of the first snap element and the second snap element comprises a first circumferential groove and the other of first snap element and the second snap element comprises a first circumferential ridge, and wherein one of the third snap element and the fourth snap element comprises a second circumferential groove and the other of the third snap element and the fourth snap element comprises a second circumferential ridge.

3. The caster assembly of claim 2, wherein the first and second circumferential ridges are formed in the openings of the first and second sides of the housing and the first and second circumferential grooves are formed on the first and second ends of the axle, respectively.

4. The caster assembly of claim 1, wherein the housing further comprises a top portion,
a step positioned at the top portion, and
a boss positioned on top of the step, the boss comprising an opening adapted to receive the pivot pin.

5. The caster assembly of claim 3, further comprising a furniture component, wherein the boss is adapted to fit within the furniture component.

6. The caster assembly of claim 1 further comprising a pivot pin, wherein the housing comprises two pieces, each piece having an opening, the pivot pin positioned through the openings in the two pieces.

7. The caster assembly of claim 1 further comprising a pivot pin, wherein the housing further comprises an opening which receives the pivot pin, and wherein one of the pivot pin and the housing comprises a circumferential groove and the other of the pivot pin and the housing comprises a circumferential ridge disposed in the groove with a snap fit arrangement.

8. The caster assembly of claim 1 wherein the wheel and the housing are made at least in part of plastic.

9. The caster assembly of claim 1 wherein the axle and the pivot pin are made at least in part of steel.

10. The caster assembly of claim 1 further comprising an attachment plate, wherein the pivot pin is attached to the attachment plate.

11. A caster assembly comprising:
a pivot pin;
a first housing, the first housing comprising a first top portion and a first side portion, the first top portion having a first pin opening;
a second housing comprising a second top portion and a second side portion, the second top portion having a second pin opening, wherein the pivot pin passes through the first and second pin openings;
an axle extending between the first side portion and the second side portion, the axle comprising a first end portion and a second end portion connected to the first side portion and the second side portion, respectively; and
a wheel disposed between the first side portion and the second side portion, the wheel having a central axial opening, wherein the axle is positioned in the central axial opening.

12. The caster assembly of claim 11, wherein the main housing further comprises:
a step positioned at the top of the main housing; and
a boss positioned on top of the step, the boss comprising an opening adapted to receive the pivot pin.

13. The caster assembly of claim 12, further comprising a furniture component, wherein the boss is adapted to fit within the furniture component.

14. The caster assembly of claim 11 wherein one of the first pin opening and the pivot pin comprises a circumferential ridge, and the other of the first pin opening and the pivot pin comprises a circumferential groove disposed in the ridge with a snap fit engagement.

15. The caster assembly of claim 11 wherein one of the second pin opening and the pivot pin comprises a circumferential ridge, and the other of the second pin opening and the pivot pin comprises a circumferential groove disposed in the ridge with a snap fit engagement.

16. The caster assembly of claim 11 wherein the wheel and the housing are made at least in part of plastic.

17. The caster assembly of claim 11 wherein the axle and the pivot pin are made at least in part of steel.

18. The caster assembly of claim 11 further comprising an attachment plate, wherein the pivot pin is attached to the attachment plate.

19. The caster assembly of claim 11, wherein one of the first housing and the first end of the axle comprises a first circumferential groove and the other of the first housing and the first end of the axle comprises a first circumferential ridge disposed in the first groove with a snap fit arrangement, and wherein one of the second housing and the second end of the axle comprises a second circumferential groove and the other of the second housing and the second end of the axle comprises a second circumferential ridge disposed in the second groove with a snap fit arrangement.

20. The caster assembly of claim 19, wherein the first and second circumferential ridges are formed in the openings of the first housing and the second housing, respectively, and the first and second circumferential grooves are formed on the first and second ends of the axle, respectively.

21. A method of assembling a caster assembly, the method comprising:
providing a housing comprising a first side portion and a second side portion, wherein the first side portion and the second side portion each have an axle opening;
providing a wheel, wherein the wheel comprises a central axial opening;
providing an axle, the axle comprising a first and second end portion;
inserting the axle in the central axial opening of the wheel;
snap fitting the first end portion of the axle into the first axle opening; and
snap fitting the second end portion of the axle into the second axle opening.

22. The method of claim 21 wherein one of the first side portion of the housing and the first end portion of the axle comprises a first circumferential groove and the other of the first side portion of the housing and the first end portion of the axle comprises a first circumferential ridge, and wherein one of the second side portion of the housing and the second end of the axle comprises a second circumferential groove and the other of the second side portion of the housing and the second end of the axle comprises a second circumferential ridge.

23. The method of claim 22, wherein the first and second circumferential ridges are formed in the openings of the first and second sides of the housing and the first and second circumferential grooves are formed on the first and second ends of the axle, respectively.

24. The method of claim 21, further comprising
providing a pivot pin, wherein the housing further comprises an opening which receives the pivot pin, and wherein one of the pivot pin and the housing comprises a circumferential groove and the other of the pivot pin and the housing comprises a circumferential ridge; and
snap fitting the pivot pin into the opening in the housing

25. A method of assembling a caster assembly, the method comprising:
providing a first housing, the first housing comprising a first top portion and a first side portion, the first top portion having a first pin opening, the first side portion having a first axle opening;
providing a second housing, the second housing comprising a second top portion and a second side portion, the second top portion having a second pin opening, the second side portion having a second axle opening;
providing a wheel, wherein the wheel comprises a central axial opening;
providing an axle, the axle comprising first and second end portions;
inserting the axle in the central axial opening of the wheel;
inserting the first end portion of the axle into the first axle opening;
inserting the second end portion of the axle into the second axle opening;
providing a pivot pin;
inserting the pivot pin into the first pin opening and the second pin opening.

26. The method of claim 25, further comprising snap fitting the pivot pin into the first pin opening.

27. The method of claim 25, further comprising snap fitting the pivot pin into the second pin opening.

28. The caster assembly of claim 25, further comprising snap fitting the first end portion of the axle into the first axle opening and snap fitting the second end portion into the second axle opening.
